(19) United States
(12) Patent Application Publication
(10) Pub. No.: US 2026/0168635 A1
(43) Pub. Date: Jun. 18, 2026

(54) VEHICLE LAMP MODULE AND VEHICLE LAMP INCLUDING THE SAME

(71) Applicant: HYUNDAI MOBIS CO., LTD., Seoul (KR)

(72) Inventors: Tae Yang PARK, Yongin-si (KR); Na Ram JUN, Yongin-si (KR); Hyun Soo LEE, Yongin-si (KR)

(73) Assignee: HYUNDAI MOBIS CO., LTD., Seoul (KR)

(21) Appl. No.: 19/387,904

(22) Filed: Nov. 13, 2025

(30) Foreign Application Priority Data
Dec. 17, 2024 (KR) 10-2024-0188990
Dec. 17, 2024 (KR) 10-2024-0188991

(51) Int. Cl. F21S 41/24; F21S 41/32; F21S 41/36; F21V 7/00; F21W 102/13; F21Y 101/00; F21Y 115/10

(52) U.S. Cl. CPC F21S 41/24; F21S 41/322; F21S 41/323; F21S 41/36; F21V 7/0033; F21W 2102/13; F21Y 2101/00; F21Y 2115/10

(57) ABSTRACT

A vehicle lamp module and a vehicle lamp including same are provided. The vehicle lamp module included a light source to emit light, and a light guide part provided at one side of the light source. The light guide part includes a front surface portion, a rear surface portion and facing the light source, an upper surface portion connected to the front surface portion and the rear surface portion, a lower surface portion connected to the front surface portion and the rear surface portion, and lateral surface portions defining lateral surfaces of the light guide part based on a leftward/rightward direction (W). The lateral surface portion includes a front protruding region including a portion protruding forward from the front surface portion. Light, which is emitted from the light source and introduced into the front protruding region, moves forward while being totally reflected in the front protruding region.

### CROSS-REFERENCE TO RELATED APPLICATION

This application claims priority to and the benefit under 35 USC § 119(a) of Korean Patent Application Nos. 10-2024-0188990 and 10-2024-0188991 filed in the Korean Intellectual Property Office on Dec. 17, 2024, the entire contents of which are incorporated herein by reference for all purposes.

### BACKGROUND

### 1. Field

The present disclosure relates to a vehicle lamp and a vehicle lamp including the same.

### 2. Description of the Related Art

There is a case in which a plurality of lamp modules are mounted in a vehicle to form a single type of light distribution pattern. The plurality of lamp modules each form a local light distribution pattern, and the local light distribution patterns formed by the plurality of lamp modules are collected to form one light distribution pattern.

Meanwhile, in case that the plurality of lamp modules are mounted, the plurality of lamp modules need to be disposed to be physically close to one another. However, in the related art, there is a problem in that glare occurs because light beams emitted from the lamp modules, which are disposed to be physically close to one another, intersect one another. That is, in the related art, there is a problem in that glare occurs because of some of light beams emitted from the lamp module, introduced into another adjacent lamp module, and then propagating to the outside.

### SUMMARY

The present disclosure has been made in an effort to prevent glare that may occur in case that a plurality of lamp modules are mounted.

In a general aspect, a vehicle lamp module includes: a light source configured to emit light; and a light guide part provided at one side of the light source, wherein the light guide part includes: a front surface portion defining a front region of the light guide part; a rear surface portion defining a rear region of the light guide part and facing the light source; an upper surface portion connected to the front surface portion and the rear surface portion and defining an upper region of the light guide part; a lower surface portion connected to the front surface portion and the rear surface portion and defining a lower region of the light guide part; and lateral surface portions defining lateral surfaces of the light guide part based on a leftward/rightward direction (W), wherein the lateral surface portion comprises a front protruding region comprising a portion protruding forward from the front surface portion, and wherein the front protruding region is configured such that light, which is emitted from the light source and introduced into the front protruding region, moves forward while being totally reflected in the front protruding region.

The front protruding region may protrude outward in the leftward/rightward direction (W) from the other regions of the lateral surface portion that exclude the front protruding region.

A thickness of the front protruding region in the leftward/rightward direction (W) may be constant.

The entire light guide part may be integrated.

The front protruding region may be provided only on one of the two opposite lateral surface portions of the light guide part based on the leftward/rightward direction (W).

A distance (d) by which the front protruding region protrudes from the front surface portion may be equal to or shorter than 2.0 times a focal length (f) that is a distance between the front surface portion and a horizontal focal point (F) of the front surface portion.

The distance (d) by which the front protruding region protrudes from the front surface portion may be equal to or longer than 1.0 times the focal length (f) that is the distance between the front surface portion and the horizontal focal point (F) of the front surface portion.

The light guide part may further include a light collection region formed between the upper surface portion and the lower surface portion and disposed to face the light source, wherein the light collection region has an outer surface formed to be convex rearward and comprises a curved surface section in which light emitted from the light source is totally reflected, and wherein the curved surface section has a geometric shape in which at least a part of the light emitted from the light source that is introduced into the light guide part, is totally reflected by the curved surface section, and then passes through a horizontal focal point (F) of the front surface portion.

The light emitted from the light source may pass closer to the horizontal focal point (F) of the front surface portion as the light is totally reflected by a portion of the curved surface section closer to the light source.

The light emitted from the light source may pass through a point spaced apart rearward from the horizontal focal point (F) of the front surface portion as the light is totally reflected by a portion of the curved surface section farther from the light source.

The front protruding region may be positioned so that light beams, which are totally reflected by a front end of the curved surface section among the light beams emitted from the light source, reach a rear end of the front protruding region.

The lower surface portion may further include a downward protruding region protruding downward, a light guide protruding region spaced apart forward from the downward protruding region and protruding downward, and a lower reflection region provided between the downward protruding region and the light guide protruding region and having a shape recessed upward from the downward protruding region and the light guide protruding region.

A horizontal cross-section of a rear surface of the light guide protruding region may include a portion having a convex rearward shape.

The lower reflection region may have a stepped section formed at a boundary between one side surface based on the leftward/rightward direction (W) and the other side surface based on the leftward/rightward direction (W).

The vehicle lamp module may further include a light absorption portion disposed on the front protruding region that absorbs light emitted from the light source.

The light absorption portion may be provided as a plurality of light absorption portions spaced apart from one another in a forward/rearward direction.

A vehicle lamp including the vehicle lamp module may be provided as a plurality of vehicle lamp modules spaced apart from one another in a leftward/rightward direction (W).

The vehicle lamp module may be provided as a plurality of vehicle lamp modules that are disposed to protrude forward further in one direction of the leftward/rightward direction (W).

The front protruding region may have a plate shape.

The light absorption portion may be formed over an outer surface of the front protruding region.

According to the present disclosure, it is possible to prevent glare that may occur in case that the plurality of lamp modules are mounted.

### BRIEF DESCRIPTION OF THE DRAWINGS

FIG. 1 is a perspective view of a vehicle lamp module according to the present disclosure.

FIG. 2 is a top plan view of a vehicle lamp according to the present disclosure.

FIG. 3 is an enlarged view illustrating a front protruding region of a light guide part provided in a vehicle lamp module according to another example of the present disclosure.

FIG. 4 is an enlarged top plan view illustrating a front region of a light guide part provided in a vehicle lamp module according to still another example of the present disclosure.

FIG. 5 is a view illustrating a cross-sectional structure of a stepped section formed on the light guide part of the vehicle lamp module according to the present disclosure.

FIG. 6 is an enlarged view illustrating a front protruding region of a light guide part provided in a vehicle lamp module according to yet another example of the present disclosure.

### DETAILED DESCRIPTION

Hereinafter, a vehicle lamp module and a vehicle lamp according to the present disclosure will be described with reference to the drawings.

### Vehicle Lamp Module

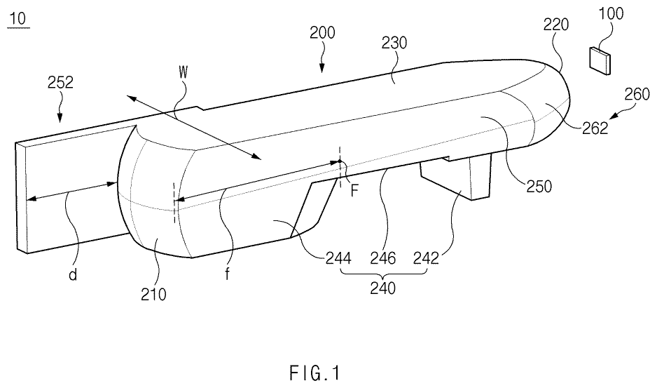

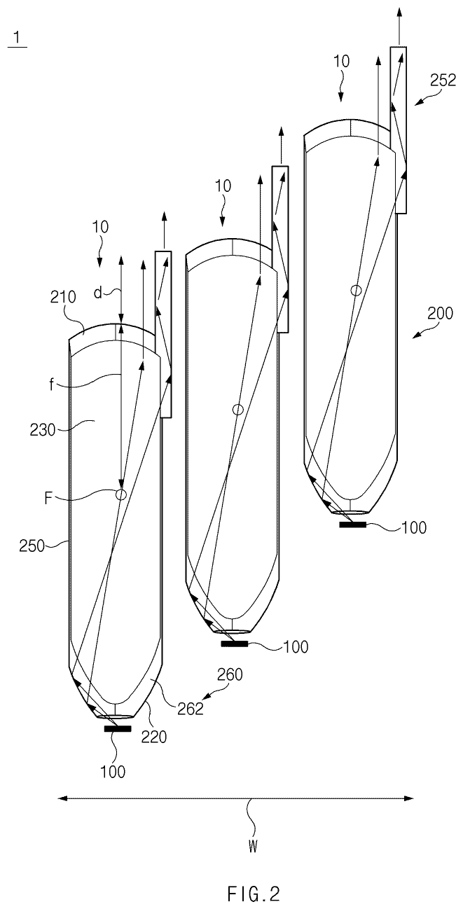

FIG. 1 is a perspective view of a vehicle lamp module according to the present disclosure, and FIG. 2 is a top plan view of a vehicle lamp according to the present disclosure.

A vehicle lamp module (hereinafter, referred to as a ‘lamp module’) according to the present disclosure may be a lamp module capable of forming a predetermined light distribution pattern. That is, the lamp module according to the present disclosure may be configured to form a low beam distribution pattern. However, the type of light distribution pattern is not limited to the above-mentioned type. The lamp module may be applied to form various types of light distribution pattern (e.g., a high-beam distribution pattern).

With reference to FIGS. 1 to 2, a lamp module 10 according to the present disclosure may include a light source 100 configured to emit light, and a light guide part 200 provided at one side of the light source 100. For example, the light source 100 may be an LED.

Meanwhile, a surface of the light guide part 200 may be divided into a plurality of regions depending on positions. More specifically, the light guide part 200 may include a front surface portion 210 configured to define a front region of the light guide part 200, a rear surface portion 220 configured to define a rear region of the light guide part 200 and face the light source 100, an upper surface portion 230 configured to connect the front surface portion 210 and the rear surface portion 220 and define an upper region of the light guide part 200, a lower surface portion 240 configured to connect the front surface portion 210 and the rear surface portion 220 and define a lower region of the light guide part 200, and lateral surface portions 250 configured to define lateral surfaces of the light guide part 200 based on a leftward/rightward direction W.

According to the present disclosure, a partial region of the lateral surface portion 250 of the light guide part 200 may have a shape protruding forward. More specifically, the lateral surface portion 250 may include a front protruding region 252 including a portion protruding forward from the front surface portion 210.

The front protruding region 252 according to the present disclosure may be configured to prevent the occurrence of glare caused by light beams that propagate to the lateral surface portion 250 without reaching the front surface portion 210 among light beams emitted from the light source 100. That is, according to the present disclosure, even though some of the light beams emitted from the light source 100 reach the lateral surface portion 250, the light beams may be prevented from propagating to the outside of the light guide part 200 in the leftward/rightward direction W.

In order to exhibit the above-mentioned function, the front protruding region 252 may be configured such that the light, which is emitted from the light source 100 and introduced into the front protruding region 252, moves forward while being totally reflected in the front protruding region 252. Therefore, like the other portions of the light guide part 200, the front protruding region 252 may be made of a light transmissive material.

Meanwhile, as illustrated in FIGS. 1 and 2, the front protruding region 252 may protrude outward in the leftward/rightward direction W from the other regions of the lateral surface portion 250 that exclude the front protruding region 252, and a thickness of the front protruding region 252 in the leftward/rightward direction W may be constant. It may be understood that the front protruding region 252 has an approximately plate-like shape.

Meanwhile, according to one example of the present disclosure, the entire light guide part 200 including the front protruding region 252 may be integrated. In this case, the configuration in which the light guide part 200 is integrated may be understood as a configuration in which the light guide part 200 is indivisibly coupled to the extent that the light guide part 200 cannot be separated unless the light guide part 200 is irreversibly destroyed.

Meanwhile, as illustrated in FIGS. 1 and 2, the front protruding region 252 may be provided only on one of the two opposite lateral surface portions 250 of the light guide part 200 based on the leftward/rightward direction W. However, unlike the above-mentioned configuration, the front protruding regions 252 may, of course, be provided on the two opposite lateral surface portions 250 of the light guide part 200 based on the leftward/rightward direction W.

In addition, according to the present disclosure, a horizontal focal point F may be formed on the front surface portion 210 of the light guide part 200. In this case, as illustrated in FIGS. 1 and 2, a distance d by which the front protruding region 252 protrudes from the front surface portion 210 may be equal to or shorter than 2.0 times a focal length f, i.e., a distance between the front surface portion 210 and the horizontal focal point F of the front surface portion 210. The distance d by which the front protruding region 252 protrudes from the front surface portion 210 may be equal to or longer than 1.0 times the focal length f, i.e., the distance between the front surface portion 210 and the horizontal focal point F of the front surface portion 210.

With continued reference to FIGS. 1 and 2, the light guide part 200 may further include a light collection region 260 formed between the upper surface portion 230 and the lower surface portion 240 and provided to face the light source 100. The light collection region 260 may serve to collect the light beams emitted from the light source 100. More specifically, the light collection region 260 may have an outer surface formed to be convex rearward and include a curved surface section 262 in which the light emitted from the light source 100 is totally reflected. For example, the above-mentioned curved surface section 262 may include a portion having a collimator shape or have a collimator shape.

In this case, according to the present disclosure, the above-mentioned curved surface section 262 may have a geometric shape in which at least a part of the light emitted from the light source 100 is introduced into the light guide part 200, is totally reflected by the curved surface section 262, and then passes through the horizontal focal point F of the front surface portion 210. It may be understood that the horizontal focal point of the curved surface section 262 is consistent with the horizontal focal point F of the front surface portion 210.

More particularly, the curved surface section 262 may have a geometric shape in which the light emitted from the light source 100 passes more closely to the horizontal focal point F of the front surface portion 210 as the light is totally reflected by a portion of the curved surface section 262 closer to the light source 100. In addition, more particularly, the curved surface section 262 may have a geometric shape in which the light emitted from the light source 100 passes through a point spaced apart rearward from the horizontal focal point F of the front surface portion 210 as the light is totally reflected by a portion of the curved surface section 262 farther from the light source 100. In this case, as illustrated in FIG. 2, the light beams, which are totally reflected by a portion positioned in a front end region of the curved surface section 262 among the light beams emitted from the light source 100, may pass through the point, which is spaced apart rearward from the horizontal focal point F of the front surface portion 210, and reach the lateral surface portion 250. In this case, in order to prevent the light, which reaches the lateral surface portion 250, from causing the above-mentioned glare, the front protruding region 252 may be positioned so that the light beams, which are totally reflected by a front end of the curved surface section 262 among the light beams emitted from the light source 100, may reach the front protruding region 252. This configuration may mean that a length of the front protruding region 252 in a forward/rearward direction is sufficiently long. More particularly, the front protruding region 252 may be positioned so that the light beams, which are totally reflected by the front end of the curved surface section 262 among the light beams emitted from the light source 100, may reach a rear end of the front protruding region 252.

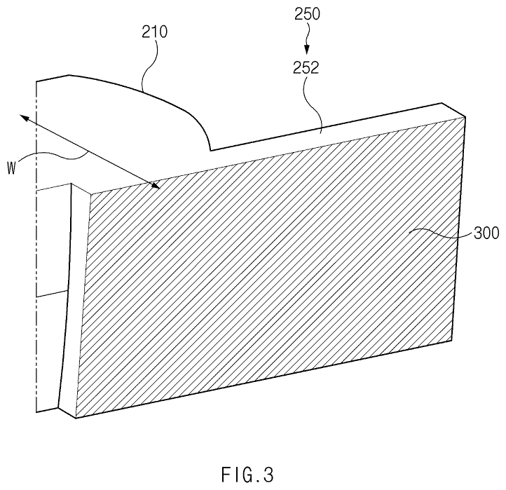

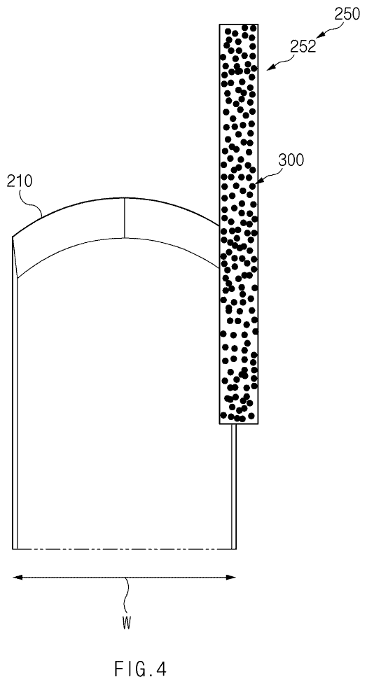

FIG. 3 is an enlarged view illustrating a front protruding region of a light guide part provided in a vehicle lamp module according to another example of the present disclosure, and FIG. 4 is an enlarged top plan view illustrating a front region of a light guide part provided in a vehicle lamp module according to still another example of the present disclosure.

Meanwhile, according to another example of the present disclosure, a light absorption portion 300 may be formed on the front protruding region 252 and absorb the light emitted from the light source 100. The light absorption portion 300 may be configured to absorb the light, which is emitted from the light source 100 and reaches the front protruding region 252, thereby more actively preventing the above-mentioned glare.

As illustrated in FIG. 3, the light absorption portion 300 may be configured separately from the light guide part 200 and formed on a surface of the front protruding region 252. In this case, more particularly, the light absorption portion 300 may be formed over an entire outer surface of the surface of the front protruding region 252 based on the leftward/rightward direction W. In this case, the front protruding region 252 may be made of the same material (i.e., light transmissive material) as the other portions of the light guide part 200 that exclude the front protruding region 252. The light absorption portion 300 may have a layered structure formed on the surface of the front protruding region 252 by coating or the like. In this case, the above-mentioned layered structure may be a black layered structure.

However, unlike the above-mentioned configuration, the light absorption portion 300 may be integrated with the light guide part 200. More specifically, with reference to FIG. 4, the front protruding region 252 may be made of or include a material different from those of the other portions of the light guide part 200 that exclude the front protruding region 252. In this case, the material included in the front protruding region 252 may be a material that absorbs the light emitted from the light source 100, and the light absorption portion 300 may be made of the material included in the front protruding region 252. That is, in this case, the light absorption portion 300 may correspond to a light absorption material distributed in the front protruding region 252. For example, the front protruding region 252, which includes the light absorption portion 300, and the other regions, which exclude the front protruding region 252, may be manufactured together by dual injection molding. Meanwhile, the descriptions of the components excluding the light absorption portion of the lamp module according to another example and still another example of the present disclosure may be replaced with the descriptions of the components described above with reference to FIGS. 1 and 2.

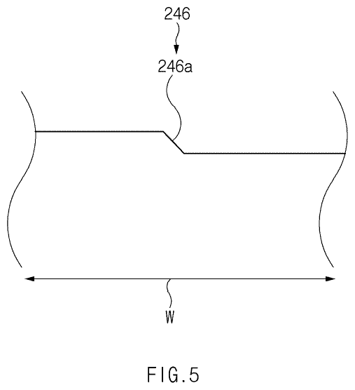

FIG. 5 is a view illustrating a cross-sectional structure of a stepped section formed on the light guide part of the vehicle lamp module according to the present disclosure.

With reference to FIGS. 1, 2, and 5, the lower surface portion 240 of the light guide part 200 may further include a downward protruding region 242 protruding downward, a light guide protruding region 244 spaced apart forward from the downward protruding region 242 and protruding downward, and a lower reflection region 246 provided between the downward protruding region 242 and the light guide protruding region 244 and having a shape recessed upward from the downward protruding region 242 and the light guide protruding region 244. For example, as illustrated in FIG. 1, a horizontal cross-section of a rear surface of the light guide protruding region 244 may include a portion having a shape convex rearward.

The lower reflection region 246 may be configured to be involved in forming a first light distribution pattern. That is, the light emitted from the light source 100 may be reflected by the lower reflection region 246 and then move upward and forward.

Meanwhile, in case that the light distribution pattern formed by the lamp module 10 according to the present disclosure is a low beam distribution pattern, as described above, the lower reflection region 246 may have a stepped section 246a formed at a boundary between one side surface based on the leftward/rightward direction W and the other side surface based on the leftward/rightward direction W. Based on the boundary of the stepped section 246a, one side surface of the lower reflection region 246 based on the leftward/rightward direction W and the other side surface of the lower reflection region 246 based on the leftward/rightward direction W may be different in height in an upward/downward direction H from each other. The above-mentioned stepped section 246a may have a shape corresponding to a cut-off line defined at an upper boundary of the low beam distribution pattern.

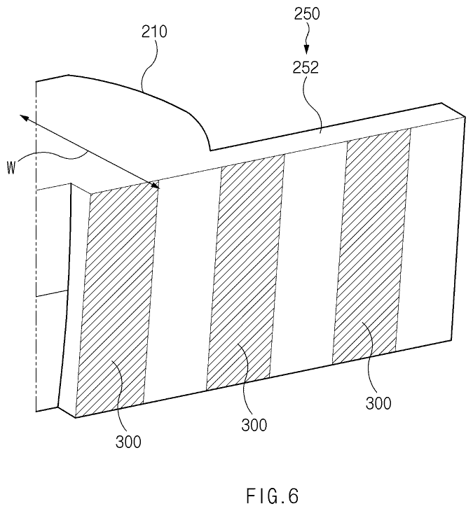

FIG. 6 is an enlarged view illustrating a front protruding region of a light guide part provided in a vehicle lamp module according to yet another example of the present disclosure.

Meanwhile, as illustrated in FIG. 6, according to the present disclosure, the light absorption portion 300 may be provided as a plurality of light absorption portions 300 spaced apart from one another in the forward/rearward direction in case that the light absorption portion 300 having the layered structure is formed on the outer surface of the front protruding region 252 based on the leftward/rightward direction W.

### Vehicle Lamp

A vehicle lamp according to the present disclosure will be described based on the above-mentioned description.

With reference to FIG. 2 and the like, a vehicle lamp 1 (hereinafter, referred to as a ‘lamp’) according to the present disclosure may include a plurality of vehicle lamp modules 10 provided to be spaced apart from one another in the leftward/rightward direction W. The description of the lamp module provided in the lamp according to the present disclosure may be replaced with the above-mentioned description for the lamp module according to the present disclosure.

In this case, the plurality of lamp modules 10 provided in the lamp 1 may be disposed to protrude forward further in one direction (the rightward direction based on FIG. 2) of the leftward/rightward direction W.

The present disclosure has been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A vehicle lamp module comprising:
a light source configured to emit light; and
a light guide part provided at one side of the light source,
wherein the light guide part comprises:
a front surface portion defining a front region of the light guide part;
a rear surface portion defining a rear region of the light guide part and facing the light source;
an upper surface portion connected to the front surface portion and the rear surface portion and defining an upper region of the light guide part;
a lower surface portion connected to the front surface portion and the rear surface portion and defining a lower region of the light guide part; and
lateral surface portions defining lateral surfaces of the light guide part based on a leftward/rightward direction (W),
wherein the lateral surface portion comprises a front protruding region comprising a portion protruding forward from the front surface portion, and
wherein the front protruding region is configured such that light, which is emitted from the light source and introduced into the front protruding region, moves forward while being totally reflected in the front protruding region.

2. The vehicle lamp module of claim 1, wherein the front protruding region protrudes outward in the leftward/rightward direction (W) from the other regions of the lateral surface portion that exclude the front protruding region.

3. The vehicle lamp module of claim 2, wherein a thickness of the front protruding region in the leftward/rightward direction (W) is constant.

4. The vehicle lamp module of claim 1, wherein the entire light guide part is integrated.

5. The vehicle lamp module of claim 1, wherein the front protruding region is provided only on one of the two opposite lateral surface portions of the light guide part based on the leftward/rightward direction (W).

6. The vehicle lamp module of claim 1, wherein a distance (d) by which the front protruding region protrudes from the front surface portion is equal to or shorter than 2.0 times a focal length (f) that is a distance between the front surface portion and a horizontal focal point (F) of the front surface portion.

7. The vehicle lamp module of claim 6, wherein the distance (d) by which the front protruding region protrudes from the front surface portion is equal to or longer than 1.0 times the focal length (f) that is the distance between the front surface portion and the horizontal focal point (F) of the front surface portion.

8. The vehicle lamp module of claim 1, wherein the light guide part further comprises a light collection region formed between the upper surface portion and the lower surface portion and disposed to face the light source,
wherein the light collection region has an outer surface formed to be convex rearward and comprises a curved surface section in which light emitted from the light source is totally reflected, and
wherein the curved surface section has a geometric shape in which at least a part of the light emitted from the light source that is introduced into the light guide part, is totally reflected by the curved surface section, and then passes through a horizontal focal point (F) of the front surface portion.

9. The vehicle lamp module of claim 8, wherein the light emitted from the light source passes closer to the horizontal focal point (F) of the front surface portion as the light is totally reflected by a portion of the curved surface section closer to the light source.

10. The vehicle lamp module of claim 8, wherein the light emitted from the light source passes through a point spaced apart rearward from the horizontal focal point (F) of the front surface portion as the light is totally reflected by a portion of the curved surface section farther from the light source.

11. The vehicle lamp module of claim 8, wherein the front protruding region is positioned so that light beams, which are totally reflected by a front end of the curved surface section among the light beams emitted from the light source, reach a rear end of the front protruding region.

12. The vehicle lamp module of claim 1, wherein the lower surface portion further comprises:
a downward protruding region protruding downward;
a light guide protruding region spaced apart forward from the downward protruding region and protruding downward; and
a lower reflection region provided between the downward protruding region and the light guide protruding region and having a shape recessed upward from the downward protruding region and the light guide protruding region.

13. The vehicle lamp module of claim 12, wherein a horizontal cross-section of a rear surface of the light guide protruding region comprises a portion having a convex rearward shape.

14. The vehicle lamp module of claim 12, wherein the lower reflection region has a stepped section formed at a boundary between one side surface based on the leftward/rightward direction (W) and the other side surface based on the leftward/rightward direction (W).

15. The vehicle lamp module of claim 1, further comprising a light absorption portion disposed on the front protruding region that absorbs light emitted from the light source.

16. The vehicle lamp module of claim 15, wherein the light absorption portion is provided as a plurality of light absorption portions spaced apart from one another in a forward/rearward direction.

17. A vehicle lamp comprising the vehicle lamp module according to claim 1, wherein the vehicle lamp module is provided as a plurality of vehicle lamp modules spaced apart from one another in a leftward/rightward direction (W).

18. The vehicle lamp of claim 15, wherein the vehicle lamp module is provided as a plurality of vehicle lamp modules that are disposed to protrude forward further in one direction of the leftward/rightward direction (W).

19. The vehicle lamp of claim 1, wherein the front protruding region has a plate shape.

20. The vehicle lamp of claim 15, wherein the light absorption portion is formed over an outer surface of the front protruding region.
